(19) United States
(12) Patent Application Publication
(10) Pub. No.: US 2007/0234485 A1
(43) Pub. Date: Oct. 11, 2007

(54) Scissors with sheath having eraser portion

(75) Inventors: Chris Peterson, Chippewa, WI (US); Chris DeSchamp, Evansville, WI (US)

Correspondence Address: FOLEY & LARDNER LLP, 321 NORTH CLARK STREET, SUITE 2800, CHICAGO, IL, 60610-4764, US

(73) Assignee: Fiskars Brands, Inc.

(21) Appl. No.: 11/399,731

(22) Filed: Apr. 7, 2006

(51) Int. Cl. B26B 11/00; B26B 3/00

(52) U.S. Cl. 7/160; 30/123

(57) ABSTRACT

A cutting device having a scissor engageable with a sheath. The blades of the scissor are stowable within the sheath. The sheath includes a housing having an opening and a hollow interior for receiving the blade of the scissors. The sheath further includes an eraser element. The eraser element is positioned on the sheath for use regardless of whether the scissor is stowed within the sheath or is not stowed within the sheath.

### BACKGROUND OF THE INVENTION

The present invention relates generally to the field of cutting devices. More particularly, the present invention is related to scissors having a sheath with an eraser element.

Users face a plethora of tools at their disposal for use in craft and hobby activities. Cutting devices such as scissors are commonly used in various craft and hobby activities. Scissors can pose an increased risk of injury if not stored properly. As such, scissors are often provided with sheaths in which the blades are stowed when not in use. However, the sheath provides little functionality beyond storage of the scissors, and the scissors and sheath do not provide for any use when the blade is stowed. At the same time, users often must use several other pieces of equipment, such as pencils, pens, and erasers in conjunction with scissors.

Therefore, there is a need for a combination cutting device which provides scissors for cutting, a sheath for storing the scissors and an eraser portion.

### SUMMARY OF THE INVENTION

One embodiment of the invention relates to a cutting device. The cutting device includes a pair of scissors having a first blade assembly and a second blade assembly pivotally connected to each other. A blade portion of the first blade assembly and a blade portion of the second blade assembly form the blades of the scissors, while the handle portion of the first blade assembly and the handle portion of the second blade assembly form the handles of the scissors. The cutting device further comprises a sheath for at least partially stowing the scissors. The sheath includes a housing having an opening and a hollow interior for receiving the blade of the scissors. The sheath further includes an eraser portion for use when the scissors are stowed in the sheath or for use separate from the scissors. The sheath provides an eraser for use in combination with a cutting device to reduce the overall number of tools that a user must handle.

These and other objects, advantages, and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view in accordance with the principles of the present invention wherein the scissors are stowed within the sheath;

FIG. 2 is a perspective view of one embodiment of the present invention with the scissors partially withdrawn from the sheath;

FIG. 3(a)-3(g) illustrate various perspective views of a scissors sheath according one embodiment of the invention;

### DETAILED DESCRIPTION OF THE PREFERRED EMBODIMENTS

Embodiments of the present invention comprise a cutting device 10 such as scissors 12 and a corresponding sheath 14 having a eraser component 16. The sheath 14 can function as an eraser either when the scissors 12 are disposed thereon or when separate from the scissors 12 according to one embodiment.

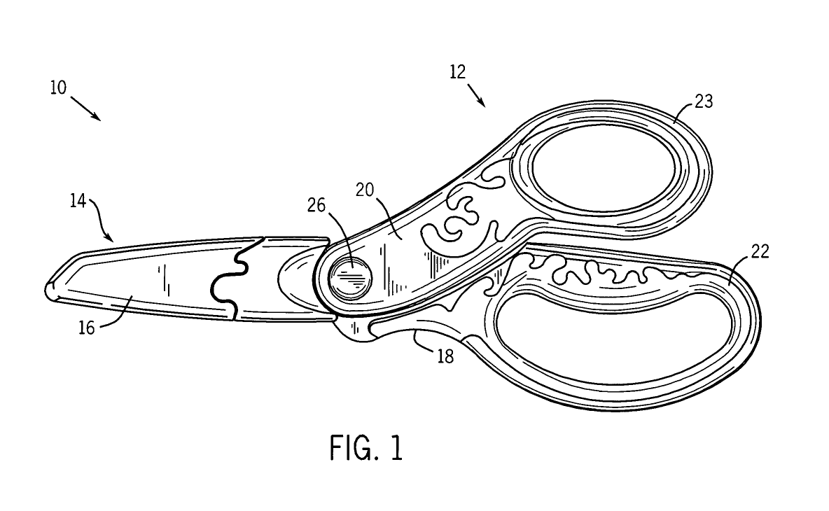

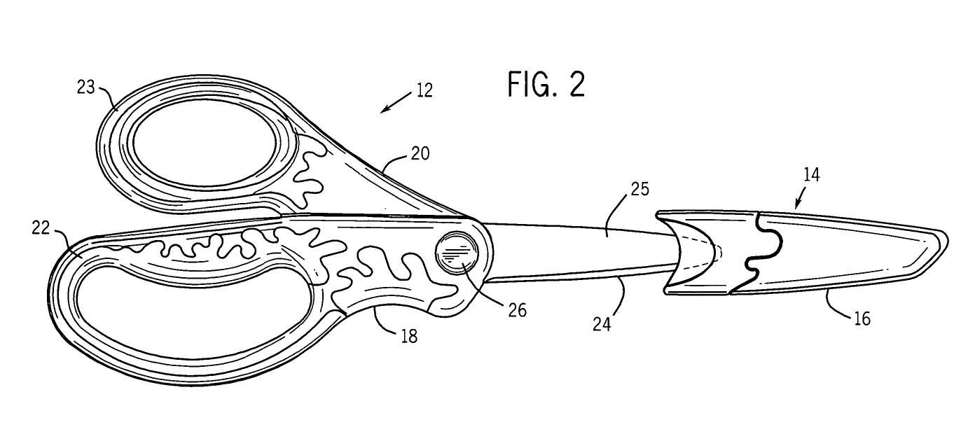

As shown in FIGS. 1 and 2, the cutting device comprises a first blade assembly 18 and a second blade assembly 20. Each blade assembly 18, 20 further comprises a handle portion 22, 23 and a cutting blade portion 24, 25. In one exemplary embodiment, each handle portion 22, 23 and cutting blade portion 24, 25 are separate pieces, with the handle portion 22, 23 and cutting blade portion 24, 25 of each respective assembly fixabley engageable with each other. For example, in one embodiment, the handle portions 22, 23 comprise molded plastic having a slot and the blade portions 24, 25 are metal and include a tang for engaging the slot.

The first blade assembly 18 and the second blade assembly 20 are pivotally connected at a pivot joint 26. The pivot joint 26 may be of any of the various types known in the art. In one exemplary embodiment, the pivot joint 26 comprises a bolt and nut. In another embodiment, the blade assemblies 18, 20 include joint mechanisms engagable with the other blade assemblies joint mechanism. The pivot joint 26 can also be constructed in accordance with the principles of the U.S. Pat. No. 4,715,122, which is incorporated herein by reference.

When the first blade assembly 18 and the second blade assembly 20 are rotatably connected at the pivot point 26, they form the scissor 12. The respective cutting portions 24, 25 forming the blade 28 of the scissors 12, and the respective handle portions 22, 23 forming the handle 30 of the scissors 12.

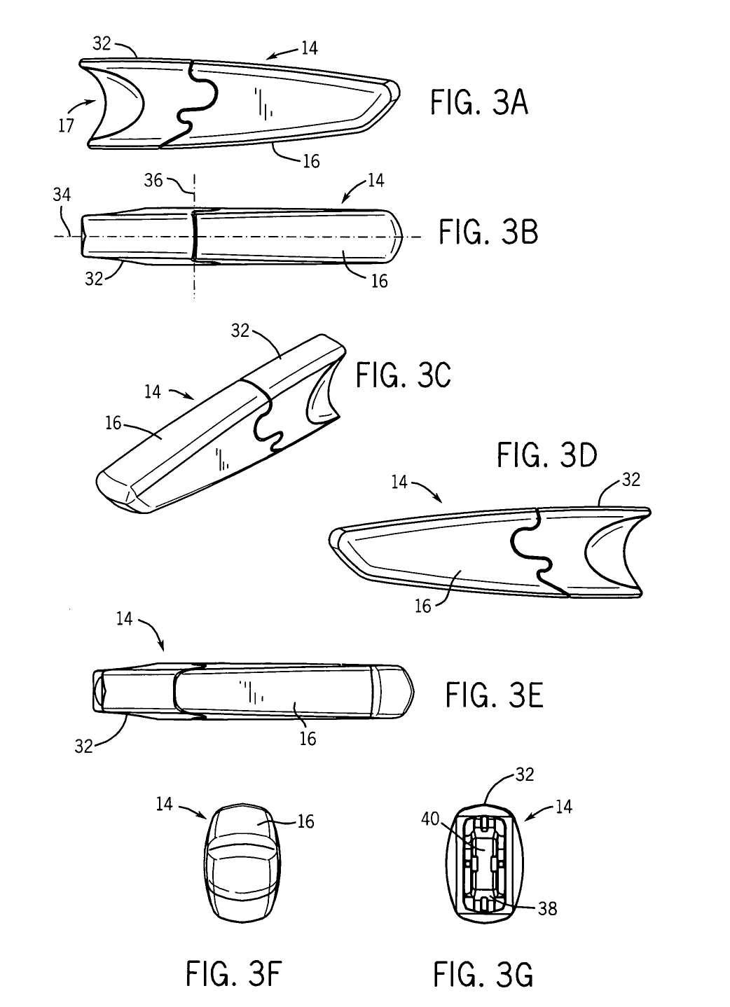

As shown in FIG. 3(a)-3(g), the sheath 14 includes a housing 32. The sheath 14 is adapted to receive at least a portion of the scissor blade 28 (i.e. the cutting blade portion 24 of the first blade assembly 18 and the cutting portion 25 of the second blade assembly 20). The sheath 14 includes a longitudinal axis 34 and a lateral axis 36. In one embodiment, the longitudinal length of the sheath 14 is longer than the lateral width. In an exemplary embodiment, the sheath 14 includes an opening 38 of sufficient size to accommodate the scissors 12 and leading to an enclosure 40 of longitudinal length for the blade 28 to be disposed within the housing 32 so that only the handle 30 protrudes from the sheath 14. In one embodiment, the sheath 14 includes a slot in communication with the opening and adapted to receive the pivot joint 26 allowing the scissor 12 to be disposed within the sheath 14 beyond the pivot joint 26.

As shown in FIGS. 4(a)-4(g), the sheath 14 includes an eraser component or element 16. The eraser element 16 may comprise any of the materials known in the art for removing pencil markings, pen markings, or other such markings. In one embodiment, the eraser is comprised of thermoplastic resin. In one embodiment, the eraser element 16 comprises a separate portion from the housing 32 and can be attached to the housing 32 via an overmolding assembly. The eraser element 16 may also be permanently affixed to the housing 32 or may be replacably removable so as to allow a user to replace the eraser element 16 when it has become practically unusable due to wear or damage. In one embodiment, the eraser element 16 is positioned substantially opposite the opening in the sheath 14 for receiving the scissors 12.

In one exemplary embodiment, the sheath 14 has a uniform contour. In one embodiment, the housing 32 includes a non-eraser portion 17 in the upper portion of the housing (i.e., nearer the opening 38) which has a contour. The eraser element 16 forms the lower portion of the housing (i.e. that opposite the opening 38) and continues the contour of the non-eraser portion to provide for a continuous contour over the entire housing 32. In one embodiment, the housing 32, including the non-eraser portion 17 and the eraser element 16, is contoured for easy of use when held by a user.

In another exemplary embodiment shown in FIG. 2, the eraser element 16 is integral to the housing 32. The eraser element 16 may form a portion of the housing 32, or the entire housing 32 may be comprised of the eraser element 16.

In use, the sheath 14 functions as an eraser. The user can apply the eraser element 16 to a desired mark to remove the mark. A user can use the sheath 14 as an eraser regardless of whether the scissors 12 are stowed within the sheath 14 or not. In an exemplary embodiment, when the scissors 12 are stowed within the sheath 14, the handle 30 of the scissor 12 acts as a handle for the sheath 14 providing a gripping surface for the user.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments, and with various modifications, as are suited to the particular use contemplated.

What is claimed is:

1. A cutting device comprising:
a scissor having a first blade assembly and a second blade assembly, each of the first and second blade assemblies having a cutting edge and a handle, the first blade assembly pivotally connected at a pivot joint to the second blade assembly; and
a sheath for engaging the first blade assembly and the second blade assembly, the sheath comprising a housing having an opening for receiving at least a portion of the first blade assembly cutting edge and the second blade assembly cutting edge, the housing having an eraser portion;
wherein the scissor is at least partially disposable within the sheath.

2. The cutting device of claim 1, wherein the opening is located at a first end of the sheath and the eraser portion is located substantially at a second end opposite the opening.

3. The cutting device of claim 1, wherein the eraser is replacably disposed in the housing.

4. The cutting device of claim 1, wherein the eraser portion comprises at least a portion of the housing.

5. The cutting device of claim 4, wherein the housing comprises substantially all eraser material.

6. The cutting device of claim 1, wherein the housing is comprised of the eraser portion and a non-eraser portion and further wherein the eraser portion and non-eraser portion have a continuous contour.

7. The cutting device of claim 1, wherein the sheath further comprises a cutout slot extending from the opening into the housing for receiving the pivot joint of the scissor.

8. A sheath for receiving and storing a pair of scissors, the sheath comprising:
an at least partially hollow housing having an opening leading into a hollow interior portion, the opening and hollow interior portion adapted for receiving at least a portion of a blade of the pair of scissors; and
an eraser portion positioned substantially opposite the opening along a longitudinal axis of the sheath;
wherein the opening is located at a first end of the sheath and the eraser portion is located substantially at a second end opposite the opening.

9. The sheath of claim 8, wherein the eraser is replacably disposed in the housing.

10. The sheath of claim 8, wherein the eraser portion forms at least a part of the housing.

11. The sheath of claim 10, wherein the housing comprises substantially all eraser material.

12. The sheath of claim 8, further comprising a cutout slot extending from the opening into the housing for receiving the pivot joint of the scissor.

13. The sheath of claim 8, wherein the housing is comprised of the eraser portion and a non-eraser portion and further wherein the eraser portion and non-eraser portion have a continuous contour.
